(19) United States
(12) Patent Application Publication
(10) Pub. No.: US 2012/0024636 A1
(43) Pub. Date: Feb. 2, 2012

(54) ELEVATOR DERAILMENT DETECTING APPARATUS

(75) Inventor: Takeshi Niikawa, Tokyo (JP)

(73) Assignee: MITSUBISHI ELECTRIC CORPORATION, Tokyo (JP)

(21) Appl. No.: 13/262,876

(22) PCT Filed: Jul. 23, 2009
(86) PCT No.: PCT/JP09/63175

§ 371 Date: Oct. 4, 2011

(51) Int. Cl. B66B 3/00

(52) U.S. Cl. 187/391

(57) ABSTRACT

In an elevator derailment detecting apparatus, first and second conducting wires are disposed parallel to a direction of raising and lowering of an ascending/descending body inside a hoistway. First and second contacts that respectively contact the first and second conducting wires if the ascending/descending body disengages from a guide rail are mounted to the ascending/descending body. The first conducting wire is set to positive electric potential, and the second conducting wire is set to ground electric potential. The detecting portion detects by the presence or absence of conduction between the first contact and the first conducting wire whether or not the ascending/descending body is disengaged from the guide rail.

### TECHNICAL FIELD

The present invention relates to an elevator derailment detecting apparatus that detects disengagement of an ascending/descending body from a guide rail due to earthquakes, etc.

### BACKGROUND ART

In conventional elevator derailment detecting apparatuses, a contact is mounted to a counterweight, and an electrical conductor is installed parallel to a guide rail inside a hoistway. Thus, if the counterweight disengages from the guide rail, dislodgment is detected by the contact contacting the electrical conductor (see Patent Literature 1 and 2, for example).

### CITATION LIST

### Patent Literature

### [Patent Literature 1]

Japanese Utility Model Laid-Open No. SHO 53-145668 (Gazette)

### [Patent Literature 2]

Japanese Patent Laid-Open No. 2003-321169 (Gazette)

### SUMMARY OF THE INVENTION

### Problem to be Solved by the Invention

Because conventional derailment detecting apparatuses such as those described above are configured on the assumption that the ascending/descending body is grounded by a main rope that is constituted by an electrical conductor, it has not been possible to detect counterweight derailment if a main rope is used that has an outer circumference that is covered by an insulating body.

The present invention aims to solve the above problems and an object of the present invention is to provide an elevator derailment detecting apparatus that can detect derailment of an ascending/descending body even if the ascending/descending body is not grounded by a main rope.

### MEANS FOR SOLVING THE PROBLEM

In order to achieve the above object, according to one aspect of the present invention, there is provided an elevator derailment detecting apparatus including: first and second conducting wires that are disposed inside a hoistway parallel to a direction of raising and lowering of an ascending/descending body; a first contact that is mounted to the ascending/descending body, and that contacts the first conducting wire if the ascending/descending body disengages from a guide rail; a second contact that is mounted to the ascending/descending body, and that contacts the second conducting wire if the ascending/descending body disengages from the guide rail; and a detecting portion that detects contact of the first contact with the first conducting wire, wherein: the first conducting wire is set to positive electric potential; the second conducting wire is set to ground electric potential; and the detecting portion detects by presence or absence of conduction between the first contact the first conducting wire whether or not the ascending/descending body is disengaged from the guide rail.

### EFFECTS OF THE INVENTION

In an elevator derailment detecting apparatus according to the present invention, because the first conducting wire is set to positive electric potential, and the second conducting wire is set to ground electric potential, and the detecting portion detects by the presence or absence of conduction between the first contact and the first conducting wire whether or not the ascending/descending body is disengaged from the guide rail, the ascending/descending body can be set to ground electric potential if the second contact contacts the second conducting wire, enabling derailment of the ascending/descending body to be detected even if the ascending/descending body is not grounded by a main rope.

### BRIEF DESCRIPTION OF THE DRAWINGS

FIG. 1 is a side elevation that shows an example of an elevator apparatus to which a derailment detecting apparatus according to Embodiment 1 of the present invention is applied;

FIG. 2 is a rear elevation that shows a counterweight from FIG. 1;

FIG. 3 is a plan that shows the counterweight from FIG. 2;

FIG. 4 is a plan that shows part of an elevator derailment detecting apparatus according to Embodiment 2 of the present invention;

FIG. 5 is a plan that shows part of an elevator derailment detecting apparatus according to Embodiment 3 of the present invention;

FIG. 6 is a plan that shows part of an elevator derailment detecting apparatus according to Embodiment 4 of the present invention;

FIG. 7 is a plan that shows part of an elevator derailment detecting apparatus according to Embodiment 5 of the present invention; and

FIG. 8 is a plan that shows part of an elevator derailment detecting apparatus according to Embodiment 6 of the present invention.

### DESCRIPTION OF EMBODIMENTS

Preferred embodiments of the present invention will now be explained with reference to the drawings.

### Embodiment 1

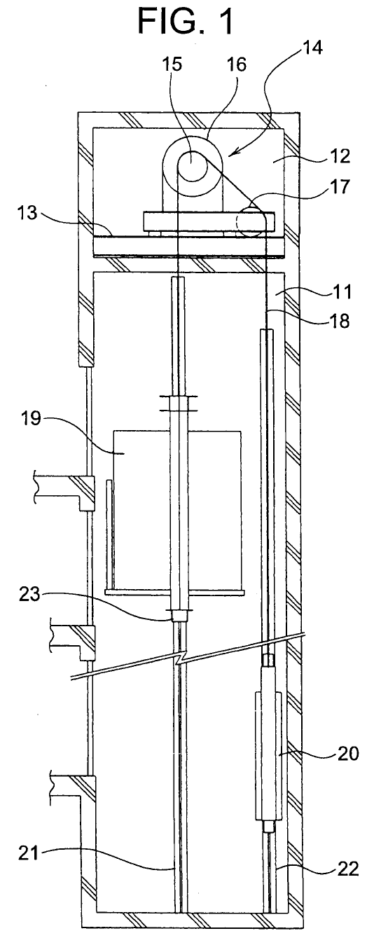

FIG. 1 is a side elevation that shows an example of an elevator apparatus to which a derailment detecting apparatus according to Embodiment 1 of the present invention is applied. In the figure, a machine room 12 is disposed in an upper portion of a hoistway 11. A machine base 13 is installed inside the machine room 12. A hoisting machine 14 is supported on the machine base 13. The hoisting machine 14 has a driving sheave 15 and a hoisting machine main body 16. The hoisting machine main body 16 has: a hoisting machine motor that rotates the driving sheave 15; and a hoisting machine brake that brakes the rotation of the driving sheave 15.

A deflecting sheave 17 is mounted to the machine base 13. A plurality of main ropes 18 that function as a suspending means are wound around the driving sheave 15 and the deflecting sheave 17. Ropes or belts are used as the main ropes 18. The main ropes 18 include: an inner layer that includes a plurality of steel strands; and a resin coating layer (an insulator layer) that is coated onto an outer circumference of the inner layer.

A car 19 is suspended on first end portions of the main ropes 18. Specifically, the car 19 is suspended inside the hoistway 11 by the main ropes 18 on a first side of the driving sheave 15. A counterweight 20 that constitutes an ascending/descending body is suspended on second end portions of the main ropes 18. Specifically, the counterweight 20 is suspended by the main ropes 18 on a second side of the driving sheave 15.

A pair of car guide rails 21 that guide raising and lowering of the car 19 and a pair of counterweight guide rails 22 that guide raising and lowering of the counterweight 20 are installed inside the hoistway 11. The car guide rails 21 are disposed vertically so as to face each other. The counterweight guide rails 22 are disposed vertically so as to face each other.

The counterweight 20 is disposed behind the car 19 so as to face a back surface of the car 19 when positioned level with the car 19. A safety device 23 that makes the car 19 perform an emergency stop by engaging with the car guide rails 21 is mounted to the car 19.

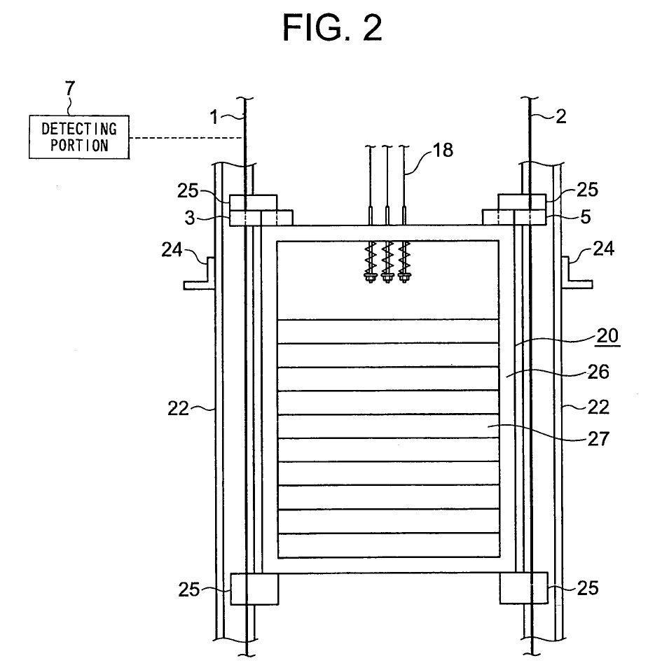

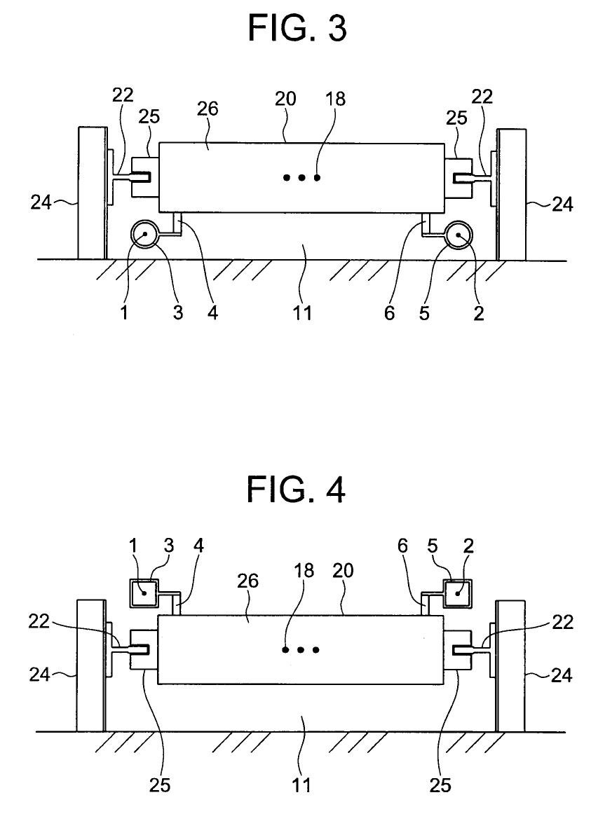

FIG. 2 is a rear elevation that shows a counterweight 20 from FIG. 1, and FIG. 3 is a plan that shows the counterweight 20 from FIG. 2. The counterweight guide rails 22 are fixed to wall surfaces of the hoistway 11 by a plurality of rail brackets 24. A plurality of (in this example, four) counterweight guide shoes 25 that engage with the counterweight guide rails 22 are mounted to the counterweight 20.

Roller guide shoes or sliding guide shoes are used as the counterweight guide shoes 25. The counterweight guide shoes 25 are mounted to upper and lower end portions on two sides in a width direction of the counterweight 20.

The counterweight 20 has: a metal frame body 26; and a plurality of weight main bodies 27 that are stacked inside the frame body 26. The main ropes 18 are connected to an upper end portion of the frame body 26.

First and second conducting wires 1 and 2 are disposed inside the hoistway 11 in a vicinity of the counterweight 20. The first and second conducting wires 1 and 2 are disposed parallel to the direction of raising and lowering of the counterweight 20, i.e., vertically, over almost an entire length of the hoistway 11. A predetermined tension is applied to the first and second conducting wires 1 and 2.

The first conducting wire 1 is disposed in a vicinity of one of the counterweight guide rails 22, i.e., in a vicinity of a first end portion in the width direction of the counterweight 20. The second conducting wire 2 is disposed in a vicinity of one of the counterweight guide rails 22, i.e., in a vicinity of a second end portion in the width direction of the counterweight 20. The first and second conducting wires 1 and 2 are disposed on an opposite side of the counterweight guide rails 22 from the car 19 (the hoistway wall side).

A ring-shaped first contact 3 is mounted to a first end portion in a width direction of an upper end portion of the frame body 26 by means of a first supporting body 4. The first conducting wire 1 is inserted approximately centrally through the first contact 3. In other words, the first contact 3 surrounds the first conducting wire 1 so as to have a predetermined clearance.

A ring-shaped second contact 5 is mounted to a second end portion in a width direction of an upper end portion of the frame body 26 by means of a second supporting body 6. The second conducting wire 2 is inserted approximately centrally through the second contact 5. In other words, the second contact 5 surrounds the second conducting wire 2 so as to have a predetermined clearance.

The first contact 3, the first supporting body 4, the second contact 5, and the second supporting body 6 are each constituted by an electroconductive material. The first contact 3 and the second contact 5 are electrically connected through the first supporting body 4, the frame body 26, and the second supporting body 6.

If the counterweight 20 disengages from the counterweight guide rails 22 and displaces horizontally, the first contact 3 contacts the first conducting wire 1, and the second contact 5 contacts the second conducting wire 2. The first and second contacts 3 and 5 have an identical shape and an identical size to each other, and come into contact with the first and second conducting wires 1 and 2 almost simultaneously in the event of derailment of the counterweight 20.

During normal operation of the elevator, the first conducting wire 1 is set to positive electric potential, and the second conducting wire 2 is set to ground electric potential. A detecting portion 7 (FIG. 2) that detects contact of the first contact 3 with the first conducting wire 1 is connected to the first conducting wire 1. The detecting portion 7 detects by the presence or absence of conduction between the first contact 3 and the first conducting wire 1 whether or not the counterweight 20 is disengaged from the counterweight guide rails 22. An electric potential detector that detects the electric potential of the first conducting wire 1, for example, is used as the detecting portion 7.

The derailment detecting apparatus according to Embodiment 1 includes the first and second conducting wires 1 and 2, the first and second contacts 3 and 5, the first and second supporting bodies 4 and 6, and the detecting portion 7.

Next, operation will be explained. If the counterweight 20 disengages from the counterweight guide rails 22 due to an earthquake, etc., the counterweight 20 is displaced frontward, rearward, to the left, or to the right from the normal raising and lowering position. At that point, the first and second contacts 3 and 5 are displaced together with the counterweight 20, and come into contact with the first and second conducting wires 1 and 2, respectively.

When the first and second contacts 3 and 5 come into contact with the first and second conducting wires 1 and 2, respectively, the first conducting wire 1 is electrically connected to the second conducting wire 2 through the first contact 3, the first supporting body 4, the frame body 26, the second supporting body 6, and the second contact 5, and reaches identical electric potential to the second conducting wire 2, i.e., ground electric potential. When the first conducting wire 1 reaches ground electric potential, this is detected by the detecting portion 7, and disengagement of the counterweight 20 from the counterweight guide rails 22 is detected.

In a derailment detecting apparatus of this kind, because the counterweight 20 is set to ground electric potential when the second contact 5 contacts the second conducting wire 2, it becomes possible to detect derailment of the counterweight 20 even if surfaces of the main ropes 18 are covered by insulating bodies and the counterweight 20 is not grounded by the main ropes 18.

Because the first and second conducting wires 1 and 2 are disposed in a vicinity of the counterweight guide rails 22, the occurrence of derailment can be detected immediately.

In addition, because the first and second contacts 3 and 5 are configured so as to have identical shape and identical size to each other, the type of contact 3 and 5 can be unified, enabling manufacturing costs to be reduced.

In addition, because the first and second contacts 3 and 5 are respectively mounted to different supporting bodies 4 and 6, layout freedom can be improved.

### Embodiment 2

Next, FIG. 4 is a plan that shows part of an elevator derailment detecting apparatus according to Embodiment 2 of the present invention. In Embodiment 1, the first and second contacts 3 and 5 had an annular shape, but in Embodiment 2, first and second contacts 3 and 5 have a quadrangular loop shape. The first and second contacts 3 and 5 are disposed nearer to a car 19 than counterweight guide rails 22. The rest of the configuration is similar to that of Embodiment 1.

According to a configuration of this kind, it is also possible to detect derailment of the counterweight 20 while using main ropes 18 in which surfaces are covered by insulating bodies, in a similar manner to Embodiment 1.

Moreover, shapes of the first and second contacts 3 and 5 are not limited to being circular or quadrangular, and may also be elliptical, triangular, polygons that are greater than or equal to pentagonal, or closed free-form curve shapes, etc.

### Embodiment 3

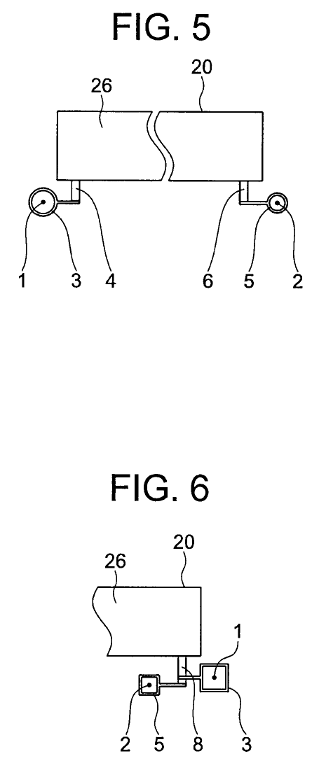

Next, FIG. 5 is a plan that shows part of an elevator derailment detecting apparatus according to Embodiment 3 of the present invention. In this example, a second contact 5 that is of smaller size (has a smaller diameter) than a first contact 3 is used. In other words, in a normal state (a state in which derailment has not occurred), clearance between the second contact 5 and a second conducting wire 2 is smaller than clearance between the first contact 3 and the first conducting wire 1. The rest of the configuration is similar to that of Embodiment 1.

In a derailment detecting apparatus of this kind, when derailment of the counterweight 20 occurs, the second contact 5 and the second conducting wire 2 come into contact, and then the first contact 3 and the first conducting wire 1 come into contact. Thus, derailment can be detected at the instant at which the first contact 3 and the first conducting wire 1 come into contact.

If the second contact 5 and the second conducting wire 2 come into contact due to building sway instead of derailment, because derailment is not detected simply by the counterweight 20 reaching ground electric potential if the first contact 3 and the first conducting wire 1 are not in contact, the risk of false detection is not increased.

### Embodiment 4

Next, FIG. 6 is a plan that shows part of an elevator derailment detecting apparatus according to Embodiment 4 of the present invention. In this example, first and second contacts 3 and 5 are mounted to a frame body 26 by means of a common supporting body 8. Consequently, the first and second conducting wires 1 and 2 are disposed in close proximity to each other. The first and second contacts 3 and 5 have quadrangular loop shapes. In addition, a second contact 5 that is smaller than the first contact 3 is used. The rest of the configuration is similar to that of Embodiment 1.

Even if the first and second contacts 3 and 5 are supported by the common supporting body 8 in this manner, it becomes possible to detect derailment of the counterweight 20 while using main ropes 18 in which surfaces are covered by insulating bodies, in a similar manner to Embodiment 1. The number of parts is also reduced, enabling manufacturing costs to be reduced.

### Embodiment 5

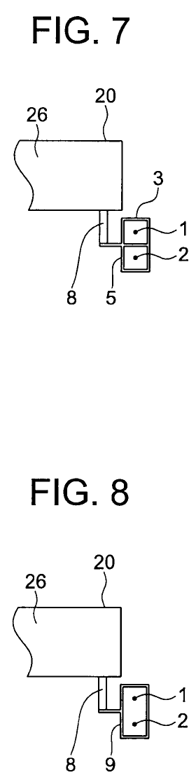

Next, FIG. 7 is a plan that shows part of an elevator derailment detecting apparatus according to Embodiment 5 of the present invention. In this example, first and second contacts 3 and 5 are integrated, and are mounted to a frame body 26 by means of a common supporting body 8. Specifically, the first and second contacts 3 and 5 have quadrangular loop shapes, and share one side. Consequently, the first and second conducting wires 1 and 2 are disposed in close proximity to each other. The rest of the configuration is similar to that of Embodiment 1.

Even if the first and second contacts 3 and 5 are integrated in this manner, it becomes possible to detect derailment of the counterweight 20 while using main ropes 18 in which surfaces are covered by insulating bodies, in a similar manner to Embodiment 1. The number of parts is also reduced, enabling manufacturing costs to be reduced.

### Embodiment 6

Next, FIG. 8 is a plan that shows part of an elevator derailment detecting apparatus according to Embodiment 6 of the present invention. In this example, a contact 9 that has a quadrangular loop shape is mounted to a frame body 26 by means of a supporting body 8. First and second conducting wires 1 and 2 are inserted approximately centrally through the contact 9. Specifically, the contact 9 surrounds the first and second conducting wires 1 and 2 together so as to leave a predetermined clearance. The first and second conducting wires 1 and 2 are disposed in close proximity to each other. The rest of the configuration is similar to that of Embodiment 1.

According to a configuration of this kind, it is also possible to detect derailment of the counterweight 20 while using main ropes 18 in which surfaces are covered by insulating bodies. The number of parts is also reduced, enabling manufacturing costs to be reduced.

Moreover, in Embodiments 1 through 6, cases in which the ascending/descending body is a counterweight 20 are shown, but the car 19 may also be set as the ascending/descending body. In other words, the contacts 3 and 5 or the contact 9 may also be mounted to the car 19 so as to detect disengagement of the car 19 from the car guide rails 21.

The present invention is naturally not limited to the elevator in FIG. 1 and can be applied to various types and layouts of elevator.

1. An elevator derailment detecting apparatus that detects disengagement from a guide rail of an ascending/descending body that is raised and lowered so as to be guided by the guide rail, the elevator derailment detecting apparatus comprising:
first and second conducting wires that are disposed inside a hoistway parallel to a direction of the raising and lowering of the ascending/descending body;
a first contact that is mounted to the ascending/descending body, and that contacts the first conducting wire if the ascending/descending body disengages from the guide rail;
a second contact that is mounted to the ascending/descending body, and that contacts the second conducting wire if the ascending/descending body disengages from the guide rail; and
a detecting portion that detects contact of the first contact with the first conducting wire, wherein:
the first conducting wire is set to positive electric potential;
the second conducting wire is set to ground electric potential; and
the detecting portion detects by presence or absence of conduction between the first contact the first conducting wire whether or not the ascending/descending body is disengaged from the guide rail.

2. An elevator derailment detecting apparatus according to claim 1, wherein the first and second contacts are loop-shaped, and respectively surround the first and second conducting wires so as to leave a predetermined clearance.

3. An elevator derailment detecting apparatus according to claim 1, wherein the first and second conducting wires are disposed in a vicinity of the guide rail.

4. An elevator derailment detecting apparatus according to claim 1, wherein the first and second contacts are configured so as to have an identical shape and an identical size to each other.

5. An elevator derailment detecting apparatus according to claim 1, wherein clearance between the second contact and the second conducting wire in a normal state is less than clearance between the first contact and the first conducting wire.

6. An elevator derailment detecting apparatus according to claim 1, wherein the first and second contacts are mounted to the ascending/descending body by means of a common supporting body.

7. An elevator derailment detecting apparatus according to claim 1, wherein the first contact and the second contact are integrated.

8. An elevator derailment detecting apparatus that detects disengagement from a guide rail of an ascending/descending body that is raised and lowered so as to be guided by the guide rail, the elevator derailment detecting apparatus comprising:
first and second conducting wires that are disposed inside a hoistway parallel to a direction of the raising and lowering of the ascending/descending body;
a contact that is mounted to the ascending/descending body, and that contacts the first and second conducting wires if the ascending/descending body disengages from the guide rail; and
a detecting portion that detects contact of the contact with the first conducting wire, wherein:
the first conducting wire is set to positive electric potential;
the second conducting wire is set-to ground electric potential; and
the detecting portion detects by presence or absence of conduction between the contact the first conducting wire whether or not the ascending/descending body is disengaged from the guide rail.
